(19) United States
(12) Patent Application Publication
(10) Pub. No.: US 2021/0158305 A1
(43) Pub. Date: May 27, 2021

(54) Contagious Status Change

(71) Applicant: Eventide Inc., Little Ferry, NJ (US)

(72) Inventor: Richard C. Factor, Sedona, AZ (US)

(21) Appl. No.: 17/101,476

(22) Filed: Nov. 23, 2020

Related U.S. Application Data
(60) Provisional application No. 62/939,146, filed on Nov. 22, 2019.

(51) Int. Cl. G06Q 10/10; G06Q 10/06

(52) U.S. Cl. CPC G06Q 10/1095; H04L 65/403; G06Q 10/063114

(57) ABSTRACT

A method of changing a device status of a plurality of electronic devices comprising detecting the device status of the plurality of electronic devices, determining a shared characteristic between the plurality of electronic devices, detecting whether the device status of each electronic device of the plurality of electronic devices having the shared characteristic is a first device status or a second device status, and changing the device status of each electronic device having the second device status to the first device status.

### CROSS-REFERENCE TO RELATED APPLICATIONS

The present application claims the benefit of the filing date of U.S. Provisional Patent Application No. 62/939,146 filed Nov. 22, 2019, the disclosure of which is hereby incorporated herein by reference.

### BACKGROUND

When holding an event involving multiple people, it is generally desirable to have the attention of the attendees and minimize distractions. Such distractions can arise from loud noises or bright lights that negatively impact the quality of the attendee's experience at that event or make the event more inefficient. For instance, when watching a movie in a cinema, it can be disruptive for a bright light or loud noise to go off as such disruptions can negatively impact the viewing quality of the other cinema-goers. Alternatively, in a work meeting, similar disruptions can negatively affect the meeting's efficiency by, for example, requiring the speaker to repeat themselves where a noise interrupted the speaker or simply making it more difficult for an attendee to pay attention.

These disruptions can occur through the use of an electronic device such as a mobile phone, smart watch, tablet, laptop, or the like. These devices provide a variety of means for notifying the user to an incoming message or alert. For instance, visual disruptions can arise from a light that flashes from a light bulb integrated on the device, or the screen might simply turn on to display the notification and provide a distraction with the screen's ambient light. Audial disruptions can arise from a noise emitted from the device when a notification arrives; or even when the device might be put on a vibrate mode to minimize the noise being emitted, the vibrating itself can be just as distracting—especially where the device is vibrating on a hard surface. Such disruptions, at best, interrupts the flow of the event and, at worst, substantively detracts from the attendees' experience and create inefficiencies in how the event is conducted.

Current solutions of mitigating these disruptions from electronic devices may include verbal reminders from the event organizers or other attendees, visual reminders form posted signs in the event, or just general politeness to manually turn off the potential means of distraction. However, such methods are unreliable and potentially ineffective. For example, it is common for electronic devices to maintain their original device status of providing distracting notifications for incoming messages throughout an event—whether through carelessness or callousness. Moreover, even where the attendee intend to change the device status to minimize or eliminate the notifications, the user may not know how to do so, do so incorrectly through user error, or do so only after the disruption has already occurred.

Thus, it is desirable for to minimize distractions to attendees of an event from electronic devices in a reliable and efficient manner.

### BRIEF SUMMARY

The present disclosure provides for a method of changing a device status of a first electronic device to match that of other device statuses from other electronic devices that have a shared characteristic with the first electronic device.

One aspect of the disclosure provides for a method of changing a device status of a plurality of electronic devices comprising detecting the device status of the plurality of electronic devices, determining a shared characteristic between the plurality of electronic devices, detecting whether the device status of each electronic device of the plurality of electronic devices having the shared characteristic is a first device status or a second device status, and changing the device status of each electronic device having the second device status to the first device status. In other aspects, the shared characteristic may be at least one of a proximity threshold, a shared calendar event, shared event invite, or being in a pre-defined group. In other aspects, the first device status and the second device status may be one of a Do Not Disturb, Available, or Silent status. In other aspects, the method may further comprise grouping the plurality of electronic devices having the shared characteristic. In other aspects, the method may further comprise comparing the plurality of electronic devices to an accepted list of electronic devices. In other aspects, the method may further comprise disregarding a first electronic device of the plurality of electronic devices where the first electronic device is not on the accepted list of electronic devices. In other aspects, the method may further comprise providing a prompt to each electronic device of the group having the second device status. In other aspects, the method may further comprise providing a prompt to each electronic device of the group having the second device status. In other aspects, providing the prompt may include providing at least one of a visual, audial, or tactile notification. In other aspects, the method may further comprise interacting with the prompt.

Another aspect of the disclosure provides for a system that includes a display, one or more electronic devices, and memory storing instructions, the instructions being executable by the one or more electronic devices, wherein the instructions comprise detecting a first device status on an electronic device of the one or more electronic devices, determining whether a second electronic device of the one or more electronic devices should be informed to enter a second device status based on a shared characteristic, generating a prompt based on the shared characteristic that includes an indication to change the second device status of the second electronic device to match the first device status of the first electronic device, and sending the prompt that includes the indication to change the second device status of the second electronic device to match the first device status of the first electronic device. In other aspects, the shared characteristic may be at least one of a proximity threshold, a shared calendar event, shared event invite, or being in a pre-defined group. In other aspects, the first device status and the second device status may be one of a Do Not Disturb, Available, or Silent status. In other aspects, the method may further comprise grouping the plurality of electronic devices having the shared characteristic into a group. In other aspects, the method may further comprise comparing the plurality of electronic devices to an accepted list of electronic devices. In other aspects, the method may further comprise disregarding any electronic device of the plurality of electronic devices that is not on the accepted list of electronic devices. In other aspects, the method may further comprise interacting with the prompt. In other aspects, the method may further comprise changing the second device status to the first device status.

A yet further aspect of the disclosure provides for a non-transitory computing-device readable storage medium on which computing-device readable instructions of a program are stored, the instructions, when executed by one or more computing devices, causing the one or more computing devices to perform a method, the method comprising setting a first electronic device of the one or more electronic devices to a first device status, establishing an accepted list of electronic devices to receive a set of instructions from, receiving the set of instructions from a second electronic device of the accepted list of electronic devices, the second electronic device having a second device status, the set of instructions including a prompt to change the first device status to a second device status, interacting with the prompt, and changing the first device status to the second device status. In other aspects, the shared characteristic may be at least one of a proximity threshold, a shared calendar event, shared event invite, or being in a pre-defined group. In other aspects, the first device status and the second device status is one of a Do Not Disturb, Available, or Silent status.

### BRIEF DESCRIPTION OF THE DRAWINGS

These and other features, aspects, and advantages of the present disclosure will become better understood with regard to the following description, and accompanying drawings.

FIG. 1 is an example network according to an aspect of the disclosure.

FIG. 2 is a flowchart depicting an example method in accordance with aspects of the disclosure.

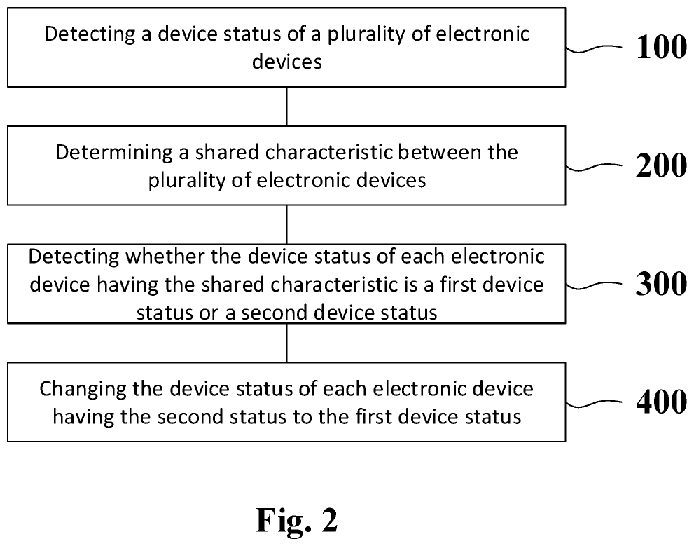

### DETAILED DESCRIPTION

As used herein, a Do Not Disturb (“DND”) status means a device status of an electronic device wherein the device only notifies the device's user of having received messages based on certain exceptions. These exceptions may include a certain number of repeat calls, calls from specific numbers, messages containing certain key words (e.g., “emergency,” “help,” or the like), or any other exceptions that may be desirable to override the DND status. However, but for these exceptions, a device with a DND status will not provide the user an audial notification, visual notification, tactile sensation, or other perceivable means of notifying that a message has been received.

Additionally, “Available” refers to a device status where the electronic device notifies the user upon receiving a message. As above, this notification may be audial, visual, tactile, or any other means of notifying the user.

“Silent” refers to a device status where the user may only receive one type of notification (e.g., a visual notification) but not others (e.g., audial or tactile).

### Overview

The present disclosure describes a method of changing the device status of a first electronic device to match the device status of a second device when the first electronic device or server detects the device status of the second electronic device, and certain parameters are met. An example of use may include a first device detecting that a second device is on DND status. Then the first device determines whether the first and second devices have at least one shared characteristic, such as proximity, shared e-calendar event, common calendar invite, or a pre-defined membership within a group. If the first and second devices have this shared characteristic, the device status of the first device may be changed to match the DND status of the second device automatically or through a prompt. In this manner, the first device can autonomously be changed to have a matching device status as the second electronic device with little to no effort on the part of the first device's user.

Whereas, previously, the device status of an electronic device may be set to be changed automatically upon a designated condition (e.g., set to DND status at a scheduled time), these prior techniques of changing a device status were limited only to the one user's device, and had no impact on the device status of other electronic devices connected over a network. This included other electronic devices that may have a shared characteristic, as described above. The present disclosure describes an improved method of changing the device status of a user device having a shared characteristic with other user devices—whether through a prompt on the device's display or an automatic change in device status. In this manner, the claimed methods and systems of the current disclosure improves upon prior computer techniques of changing the device status of multiple user devices.

### Example Arrangement

The electronic device may be any type of wearable electronic device, such as smart watches, glasses, rings, pendants, or the like. Alternatively, the electronic device may be a non-wearable electronic device such as a mobile phone, laptop, tablet, personal digital assistant (“PDA”), or the like.

The electronic (or computing) device may have an internal set of components including a processor, memory, a user interface, and a display. The processor can include one or more computer processors, such as a central processing unit (“CPU”) and/or a graphical processing unit. These computer processors are designed, in part, to receive information from a user interacting with the user interface and then displaying the information through the user interface. The processor may additionally operate in tandem with other types of hardware circuitry, such as application-specific integrated circuits, controllers, or the like. As an example, the graphical processing unit may display a prompt on the display to turn on DND status while the CPU manages overall operation of the electronic device.

The user interface may receive inputs from a user through the user's interactions with the electronic device and then can convert those inputs for use by the processor. These inputs may be received by any one, or combination, of a variety of input devices, such as a touch screen, mouse, key input, stylus, microphone, or the like. For instance, the prompt to turn on DND may appear on the display with a button to allow the user to change the device status to DND. The user may tap on the displayed button with a finger or stylus, and the tap can then be converted for use by a processor of the processor. The processor may then run an application related to changing the device status of the electronic device using instructions and data stored in the memory to set the device status of the electronic device to DND.

The memory can be one or more of a computer-readable medium or media, or a volatile/non-volatile memory unit or units, such as flash memory, random-access memory, or the like. Alternatively, the memory may be in the form of CD-ROMs, DVDs, high-density tape drives, and other types of memories. In one instance, the memory may contain a computer program or application containing instructions that, when executed by one or more processors, performs one or more methods as those described herein. In this regard, the terms “instructions,” “programs,” or “applications” may be used interchangeably herein. The instructions may be stored in an object code format for processing by one or more processors. Alternative computing device language may include collections of independent source code modules or scripts that can be either compiled in advance or interpreted on demand. The instructions may be executed by the processor(s) directly (e.g., through machine code or the like) or indirectly (e.g., through scripts or the like). The methods and functions of the instructions are explained in more detail below.

The electronic device can additionally include a communication module for communicating with other devices or systems, and may include a wireless or wired transceiver. Through the communication module, the electronic device can communicate with other devices using a number of configurations and protocols. This includes short range communication protocols such as the Internet, intranets, virtual private networks, Ethernet, WiFi and HTTP, wide area networks, local networks, private networks using communication protocols proprietary to one or more companies, near-field communication, Bluetooth™, Bluetooth™ Low Energy (“BLE”), or other ad-hoc networks, and/or a combination of the above.

In certain instances, an electronic device may be connected to a number of other devices through a network to communicate the device status of the electronic device and to determine whether there is a shared characteristic among the devices. The other devices do not have to be the same type as the electronic device. For example, the electronic device may be a mobile phone while the other devices may be a tablet, laptop, smartwatch, PDA, or any device as mentioned above. This network may be connected to a server that can provide information to the devices connected to the network (e.g., a shared event invite, scheduled calendar event, or the like) from a database connected to the server. The database securely stores data such that only authorized access is permitted. Additionally, personally identifiable information related to the device's user and/or connected devices, such as names, addresses, contact information, or the like, may be removed, and the data may instead be labeled and identified using a random or pseudo-random code, identifier, or other form of anonymous identification. Any of the devices in the network may send requests and receive query results from the server. For instance, the electronic device may send a query as to which of the other devices in the network share the same event invite. The server may employ the methods as described herein, and includes modules and components similar to those described for the electronic device above, including towards having instructions for implementing the method as described below.

The computing device components as described are not limited to being all stored within the same physical housing. As an example, the instructions may alternatively be stored on a read-only computer chip, or a removable storage medium, such as a universal serial bus drive, optical drive, high-density tape drive, or the like.

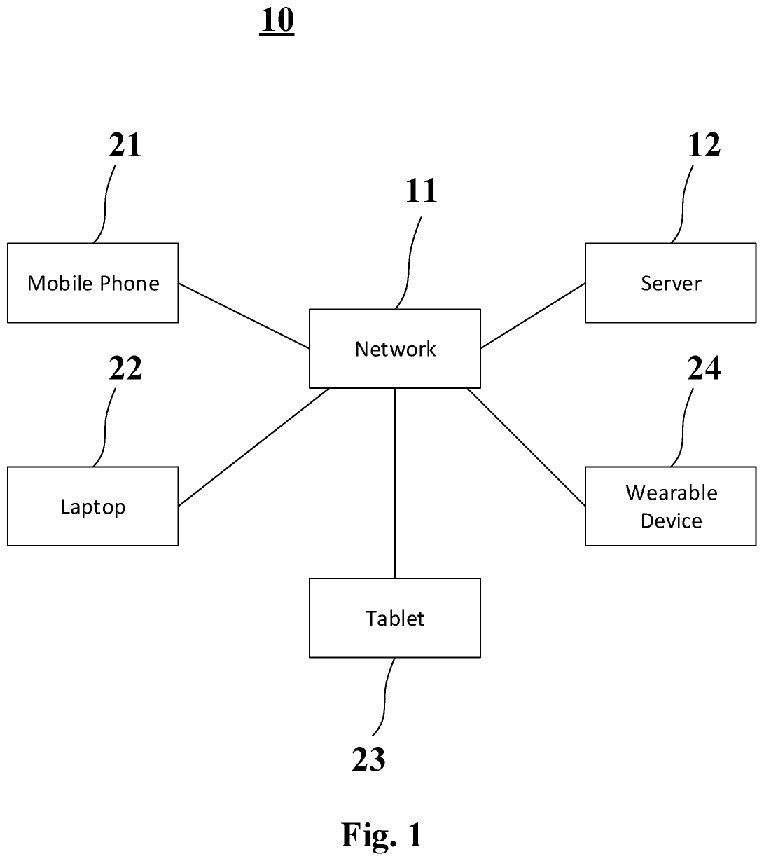

FIG. 1 depicts an example system 10. System 10 includes network 11 connecting a plurality of devices, including mobile phone 21, laptop 22, tablet 23, wearable device 24, and server 12. The devices may have a communication module, as described above, to allow for each device to communicate with another. For instance, mobile phone 21 may detect the device status of wearable device 24, determine whether wearable device 24 has a shared characteristic and device status with mobile phone 21, and send a prompt to wearable device 23. Alternatively, server 12 may house the instructions to perform the disclosed method. In this instance, tablet 23 may have an application or program installed that enables server 12, through an option enabled by the user, to access tablet 23 to, for example, detect the device status of laptop 22, determine whether laptop 22 has a shared characteristic and device status with tablet 23, and send a prompt to wearable laptop 22. In alternative aspects, system 10 may include any number of devices, including multiples of each type of device (e.g., multiple mobile phones 21 connected to network 11, or other network arrangements).

### Example Method

Aspects of this disclosure can be implemented in a variety of use cases. Examples of certain use cases are discussed below, although the technology may be employed in other situations and is not limited to those expressly provided herein. An example of use may include changing the device status of devices attending a work meeting to DND when all the electronic devices of the meeting have a shared calendar event, such as a scheduled luncheon, conference meeting, or other work-related gatherings. Alternative uses may include changing the device status of devices for devices in a social setting, such as spending time with family or friends. Further uses may include where the multiple electronic devices are attending an event, such as a play, movie, conference, or other occasions where audible or visual disturbances may be a nuisance.

An example method of use is depicted in FIG. 1. Step 100 includes detecting a device status of a plurality of electronic devices. The plurality of electronic devices may be connected to a network, as described above. As an example, a first electronic device and a second electronic device may be connected through a WiFi network. However, the electronic devices may be connected via other means, such as Bluetooth, Internet, intranet, local networks, or other means of network communications as described above. In alternative aspects, more than two devices are connected to a network and can include three, four, five, or any number of devices capable of being supported by the network. The first electronic device is set to a first device status, such as DND, while the second electronic device is set to a second device status different than the first device status, such as Available, Silent, or any other device status capable of interacting with incoming messages that is different from the first device status. This may be performed manually by the user through the device settings or an application on the device, through a scheduled change set by the user, leaving the device status upon its default factory settings, or through other means of setting the device status for an electronic device. As described above, the electronic device may be any type of wearable electronic device (e.g., smart watches, glasses, rings, pendants, or the like) or a non-wearable electronic device (e.g., mobile phone, laptop, tablet, PDA, or the like). Where there are more than two devices connected to the network, each of the electronic devices may have their own device status. For example, a first electronic device may be set to DND, a second electronic device may be set to Available, and a third electronic device may be set to Silent. In an alternative aspect, none of the electronic devices are set to DND status, and all the electronic devices are set to either Available or Silent.

In step 200, a first electronic device or server determines whether other electronic devices in the network have a shared characteristic. For example, the shared characteristic may be a shared calendar event stored within the electronic calendar of the electronic devices. The first electronic device may determine that this calendar event is shared by, for instance, checking the attendee list of the event, or a shared or accessible calendar of the electronic devices, or the like. This shared characteristic may also include where an electronic device has the same calendar invite to attend the event but the invite has not yet been accepted as, for instance, when the user has forgotten to do so. This shared calendar invite can be determined similar to the shared calendar event. In yet other aspects, the first electronic device the shared characteristic may be based on a proximity threshold (e.g., 30 feet, 40 feet, or any desired distance) that the first electronic device shares with other electronic devices. An additional shared characteristic may be that the electronic devices are a part of a pre-defined group (e.g., working for the same company or firm, a pre-defined family or friend group, or the like). Further aspects of the shared characteristics are not limited to those disclosed above and may include any characteristic capable of being shared among multiple electronic devices. In an alternative aspect, the electronic devices having the shared characteristic may be grouped together to distinguish this set of electronic devices from other electronic devices connected within the network that do not have the shared characteristic.

The above aspects of the shared characteristic can also be applied in combination. For example, the electronic devices may only be considered as having the shared characteristic where the electronic devices have the same scheduled calendar event and that are within a certain proximity threshold. This may be helpful where a scheduled major event, such as a large conference, has a number of smaller scheduled minor events, such as different presentations being held in different rooms, and all electronic devices are connected by the same WiFi network. In this instance, there may be a risk that the device status of all electronic devices in the scheduled major event may be affected when the user may only want to change the device status of those electronic devices in the scheduled major event that are also attending the same scheduled minor event. The first device may interact with the electronic devices that share the same calendar event and that also are within a certain proximity threshold. Other aspects may include incorporating all the shared characteristics described above.

Once the electronic devices in the network having a shared characteristic has been determined, step 300 shows where a first electronic device may then determine whether the electronic devices within the network and having the shared characteristic also shares a device status with the first electronic device. For instance, a first electronic device having a first device status (e.g., DND) may be able to communicate with a second electronic device having a second device status (e.g., Available or Silent) to determine that the first electronic device that the second device status is different from the first device status.

In step 400, the first electronic device can then change the device status of each electronic device having the second device status to the first device status. This may be done by sending instructions to the other electronic devices that do not share the first device status to either change the device status of the other electronic devices to match the first device status or provide a prompt to change the device status. For example, the first electronic device may have a first device status set to DND while a second electronic device may have a second device status set to either Available or Silent. The first electronic device may send instructions to the second electronic device to change the second device status to match the first device status of DND. Alternatively, the first device may send instructions to the second electronic device to provide a prompt to the second electronic device's user to change the second device status to match the first device status. The prompt may notify the user by providing at least one of an audial notification (e.g., beeping, ringing, or the like), visual notification (e.g., a flash from a screen or LED light, the prompt displaying on the screen, or the like), tactile notification (e.g. vibrating or the like), or other perceivable means of notifying the user about the prompt. For instance, the prompt may appear on the display of the second electronic device to allow the user to change the second device status directly by interacting with the prompt (e.g., pressing or tapping a button on the prompt to directly change the second device status, to open the settings menu to allow the user to change the second device status, or the like) or to simply notify the user to change the second device status. Alternatively, the prompt may be a small icon by itself or in a list of other icons (e.g., a drop down menu including an icon for airplane mode, flashlight, or the like) that flashes or provides some other visual indication of a prompt to change the device status. The method of this disclosure is not limited to two electronic devices and may include the first electronic device being able to communicate with any number of devices (e.g., two, three, four devices, or the like) within the group to both determine their respective device statuses and to provide instructions.

An additional step may include sending a prompt, as described above, to the devices having the event invite or calendar event to join a network status with other user devices. For instance, a user device may be disconnected from the network used by the other devices attending the event. In such an instance, the user device may not be detected by the above method. In this example, the method may include detecting the network status of the user device. This may include detecting whether the user device is in airplane mode, or another mode that disconnects the first device from network connectivity. Alternatively, the network status of the user device may indicate that the user device is connected to a network, but not to a preferred network as designated by the event organizers. For example, the event organizers may prefer that the devices of the users attending the event be connected via Bluetooth. In either case, a prompt may be sent to the user device to connect the user device to a preferred network. In a further alternative aspect, the user device may automatically be connected to a preferred network where, for instance, a user enables an option to have the user device's network connections be automatically changed. In an alternative aspect, the server may house the instructions to perform the above method rather than the first electronic device. For instance, users may install an application or program on their electronic device, and agree to allow the application to communicate with a server, and have secured and authorized access to certain aspects of the electronic device, such as the contact information, electronic calendar, or the like. The server may then determine the device status of the electronic devices in communication with the server, group the electronic devices based on a shared characteristic, and detect which of the electronic devices of the group share a preferred (or first) device status or have an alternative (or second) device status. The server may then change, or provide a prompt to change, the device status having an alternative device status to the preferred device status. The preferred device status may be based on a desired device status set by the event's organizers. For instance, the organizers of a workplace meeting may set the desired device status to DND for those who attend. Alternatively, the preferred device status may default to DND. For instance, the server may change all electronic devices attending a movie and having an alternative device status to the preferred device status of DND by default. As described above, the server may alternatively provide a prompt to change a device status rather than automatically changing it.

The first electronic device or server may additionally provide instructions to change the other devices back to their original device status after a certain period of time has passed (i.e., the event is over) or when the shared characteristic has expired. As with the previous instructions, this may be in the form of an automatic change or a prompt. For instance, a device status may be set to DND from Available during a play but, after the play is over, a prompt may appear on a user's device status to notify the user that they can set the device status back to Available. Alternatively, the device status may be automatically changed back to its original state.

The electronic device receiving the above-described instructions may have additional filter settings with respect to interacting with the provided instructions and, specifically, the source of the instructions. For instance, the electronic devices may have three settings: “Off,” “Accept Selected Device Status,” and “Accept Beacon Device Status.” In the “Off” setting, the electronic device will not change its original device status or provide the user a prompt, no matter where the instructions came from, without the user explicitly changing this setting. In the “Accept Selected Device Status” setting, the electronic device will only accept changes or prompts from instructions sent by an accepted list of electronic devices while disregarding the instructions provided by other electronic devices. For instance, a user's electronic device will only accept instructions from electronic devices of the user's coworkers. Alternatively, the accepted list may include the electronic devices of the user's family, friends, or the like. In the “Accept Beacon Device Status” setting, the electronic device will accept changes or prompts from instructions sent by any electronic device having the shared characteristic.

Although the disclosure herein has been described with reference to particular embodiments, it is to be understood that these embodiments are merely illustrative of the principles and applications of the present disclosure. It is therefore to be understood that numerous modifications may be made to the illustrative embodiments and that other arrangements may be devised without departing from the spirit and scope of the present disclosure as defined by the appended claims.

1. A method of changing a device status of a plurality of electronic devices comprising:
detecting, by the one or more processors, the device status of the plurality of electronic devices;
determining, by the one or more processors, a shared characteristic between the plurality of electronic devices;
detecting, by the one or more processors, whether the device status of each electronic device of the plurality of electronic devices having the shared characteristic is a first device status or a second device status; and
changing, by the one or more processors, the device status of each electronic device having the second device status to the first device status.

2. The method of claim 1, wherein the shared characteristic is at least one of a proximity threshold, a shared calendar event, shared event invite, or being in a pre-defined group.

3. The method of claim 1, wherein the first device status and the second device status is one of a Do Not Disturb (“DND”), Available, or Silent status.

4. The method of claim 1, further comprising grouping the plurality of electronic devices having the shared characteristics.

5. The method of claim 1, further comprising comparing the plurality of electronic devices to an accepted list of electronic devices.

6. The method of claim 5, further comprising disregarding a first electronic device of the plurality of electronic devices where the first electronic device is not on the accepted list of electronic devices.

7. The method of claim 1, further comprising providing a prompt to each electronic device of the group having the second device status.

8. The method of claim 7, wherein providing the prompt includes providing at least one of a visual, audial, or tactile notification.

9. The method of claim 7, further comprising interacting with the prompt.

10. A system comprising:
a display;
one or more electronic devices; and
memory storing instructions, the instructions being executable by the one or more electronic devices, wherein the instructions comprise:
detecting a first device status on an electronic device of the one or more electronic devices;
determining whether a second electronic device of the one or more electronic devices should be informed to enter a second device status based on a shared characteristic;
generating a prompt based on the shared characteristic that includes an indication to change the second device status of the second electronic device to match the first device status of the first electronic device; and
sending the prompt that includes the indication to change the second device status of the second electronic device to match the first device status of the first electronic device.

11. The system of claim 10, wherein the shared characteristic is at least one of a proximity threshold, a shared calendar event, shared event invite, or being in a pre-defined group.

12. The system of claim 10, wherein the first device status and the second device status is one of a Do Not Disturb (“DND”), Available, or Silent status.

13. The system of claim 12, further comprising grouping the plurality of electronic devices having the shared characteristic into a group.

14. The system of claim 10, further comprising comparing the plurality of electronic devices to an accepted list of electronic devices.

15. The system of claim 14, further comprising disregarding any electronic device of the plurality of electronic devices that is not on the accepted list of electronic devices.

16. The system of claim 10, further comprising interacting with the prompt

17. The system of claim 16, further comprising changing the second device status to the first device status.

18. A non-transitory computing-device readable storage medium on which computing-device readable instructions of a program are stored, the instructions, when executed by one or more computing devices, causing the one or more computing devices to perform a method, the method comprising:
setting a first electronic device of the one or more electronic devices to a first device status;
establishing an accepted list of electronic devices to receive a set of instructions from;
receiving the set of instructions from a second electronic device of the accepted list of electronic devices, the second electronic device having a second device status, the set of instructions including a prompt to change the first device status to a second device status;
interacting with the prompt; and
changing the first device status to the second device status.

19. The medium of claim 18, wherein the shared characteristic is at least one of a proximity threshold, a shared calendar event, shared event invite, or being in a pre-defined group.

20. The medium of claim 18, wherein the first device status and the second device status is one of a Do Not Disturb (“DND”), Available, or Silent status.
